(19) United States
(12) Patent Application Publication
(10) Pub. No.: US 2008/0120423 A1
(43) Pub. Date: May 22, 2008

(54) System and method of actively establishing and maintaining network communications for one or more applications

(76) Inventors: David N. Hall, Rancho Santa Margarita, CA (US); Warren Emens, Orange, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/821,245

(22) Filed: Jun. 22, 2007

Related U.S. Application Data
(60) Provisional application No. 60/860,579, filed on Nov. 21, 2006.

(51) Int. Cl. G06F 15/16

(52) U.S. Cl. 709/229

(57) ABSTRACT

According to one embodiment of the invention, a communication module, stored with machine-readable medium and executed by a processor of the electronic device, is adapted to detect signaling identifying a wake-up event and to automatically establish connectivity to a network in response to detecting the signaling.

### CROSS-REFERENCE TO RELATED PATENTS

This application is based on and claims the benefit of priority on U.S. Provisional Application No. 60/860,579 filed Nov. 21, 2006, the entire contents of which are incorporated herein by reference.

### FIELD

Embodiments of the invention generally relate to a system and method for managing network connectivity and controlling network communications for one or more applications.

### GENERAL BACKGROUND

Over the past decade, tremendous advances have been made in wireless communications, and thus, there has been an increased demand for wireless electronic devices. One reason for this increased demand is that wireless electronic devices are portable, which enables consumers to use the device in transit or when remotely located from one's home or office.

These increased advances have lead to complex communication architectures. For instance, laptop computers typically feature multiple applications that need to periodically poll a network server in order to determine if there is any data queued for that application. However, strict polling requirements are problematic, especially for portable electronic devices that consistently reside in an Advanced Configuration and Power Interface (ACPI) power-saving state (S3-S5).

Moreover, without a uniform communication protocol that is expandable and flexible enough to support the ever-growing number of integrated applications, any future integration of new applications will require modification of the communication protocol. This will result in increased costs and may increase the amount of time needed to release future generation products into the marketplace.

### BRIEF DESCRIPTION OF THE DRAWINGS

Features and advantages of embodiments of the invention will become apparent from the following detailed description in which:

FIG. 1 is an illustrative embodiment of a network implemented with a communication (MySync) module operating in accordance with an embodiment of the invention.

FIG. 2A is an exemplary embodiment of the internal architecture of the subscriber device of FIG. 1.

FIG. 2B is an illustrative embodiment of the MySync module of FIG. 1 in communication with a backend service center.

FIG. 3 is an exemplary embodiment of the external architecture of the subscriber device of FIG. 1.

FIG. 4 is illustrative embodiment of applications forming a backend service center of the network of FIG. 1.

FIG. 5 is an illustrative embodiment of the operations for a subscription service from registration to detection of an event necessitating network connectivity by the subscriber device.

FIG. 6A-6D are illustrative embodiments of screen shots for different stages of the subscription process.

FIG. 7 is an exemplary embodiment of the MySync module in operation with one or more service applications.

FIG. 8 is an exemplary embodiment of an encapsulated XML message transmitted to the MySync module over a SOAP XML interface.

FIG. 9 is an exemplary embodiment of the MySync module in operation with setting an alarmed wake-up event.

FIG. 10 is a first illustrative embodiment of the operations of the subscriber device and the backend service center.

FIG. 11 is a second illustrative embodiment of the operations of the subscriber device and the backend service center.

FIG. 12 is a first illustrative embodiment of subscription services provided by the backend service center to the subscriber device.

FIG. 13 is a second illustrative embodiment of subscription services provided by the backend service center to the subscriber device.

FIG. 14 is an exemplary embodiment of a flowchart illustrating operations performed by the subscriber device.

### DETAILED DESCRIPTION

Embodiments of the invention set forth in the following detailed description generally relate to a system, communication module and method for controlling network communications on behalf of one or more applications. Such control involves the management of polling and network connectivity as well as the query, retrieval and processing of messages including application-specific data from remotely located resources.

Herein, according to one embodiment of the invention, the communication (MySync) module operates as an interface between a network and one or more applications implemented within an electronic device. The communication module is responsible for controlling network communications and the query/retrieval of information on behalf of the applications. These applications may be configured as a suite of plug-in applications, where each plug-in application provides a service to the subscriber. One type of services provided by an application that will be described in detail for illustrative purposes is “device security,” although the MySync module may support many other application services such as syndicated content delivery.

According to one embodiment of the invention, the communication module is configured to parse encapsulated messages where such encapsulation is used as an extensible interface between the communication module and the application(s). This interface is universal and expandable to allow integration of future applications without any modification to the interface. As an example, the encapsulated message may be a collection of Extensible Markup Language (XML) documents such as one or more XML documents encapsulated within another XML document.

According to another embodiment of the invention, the communication module is configured to monitor and automatically establish network connectivity as needed. Network connectivity is needed for polling as well as for handling some scheduled tasks and request messages from the applications. When establishing Internet connectivity, the communication module may need to establish and perhaps even re-establish Internet connectivity until a routable Internet Protocol (IP) address is provided. A “routable” IP address is an address that can be routed over the Internet from a device back to the communication module.

According to yet another embodiment of the invention, the communication module implemented within an electronic device is configured to initiate network connectivity after certain events that caused the electronic device to wake from a shutdown (S5), hibernate (S4) or suspend (S3) state. The “waking” of the electronic device can be accomplished either by communications from a remote source or by setting a timer. If the electronic device is to be awaken from an S3 or S4 state, a Windows® OS based timer may be used. However, if the electronic device is to be awakened from an S3, S4 or S5 state, a Basic Input/Output System (BIOS) Real-Time Clock (RTC) wake alarm timer may be used.

As described below, the communication module provides a variety of services including those services that are used by security-based applications to protect unauthorized access of stored data from or unauthorized usage of the subscriber device. These security-based services will be described in detail for illustrative purposes. It is contemplated, however, that the communication module is configured to provide services for applications other than security-based applications.

In the following description, certain terminology is used to describe various features of one or more embodiments of the invention. For instance, a “subscriber device” is generally defined as any electronic device that is capable of establishing wired or wireless communications with a network in order to upload or download information from a resource (e.g., subscription services subnet). Examples of a subscriber device include, but are not limited or restricted to a computer (e.g., desktop, laptop, tablet, handheld, server, etc.), a router or any portable electronic device such as a personal digital assistant (PDA), a cellular telephone, an alphanumeric pager, a music player, a video or video game player, or the like.

The terms “application” and “module” generally refer to one or more code instructions that perform a particular function or functions. These instructions may be stored within machine-readable medium such as firmware or software. “Machine-readable medium” is any medium that can at least temporarily store information including, but not limited or restricted to the following: an electronic circuit, a semiconductor memory device (non-volatile or volatile), a hard disk drive, and various types of portable storage devices (e.g., flash drive, compact disc “CD”, digital versatile disk “DVD”, etc.).

A “message” is information that is arranged in a predetermined format for transmission over an interconnect, namely a wired, wireless or logical pathway. A “component” is hardware, software or firmware.

### I. Exemplary System Architecture

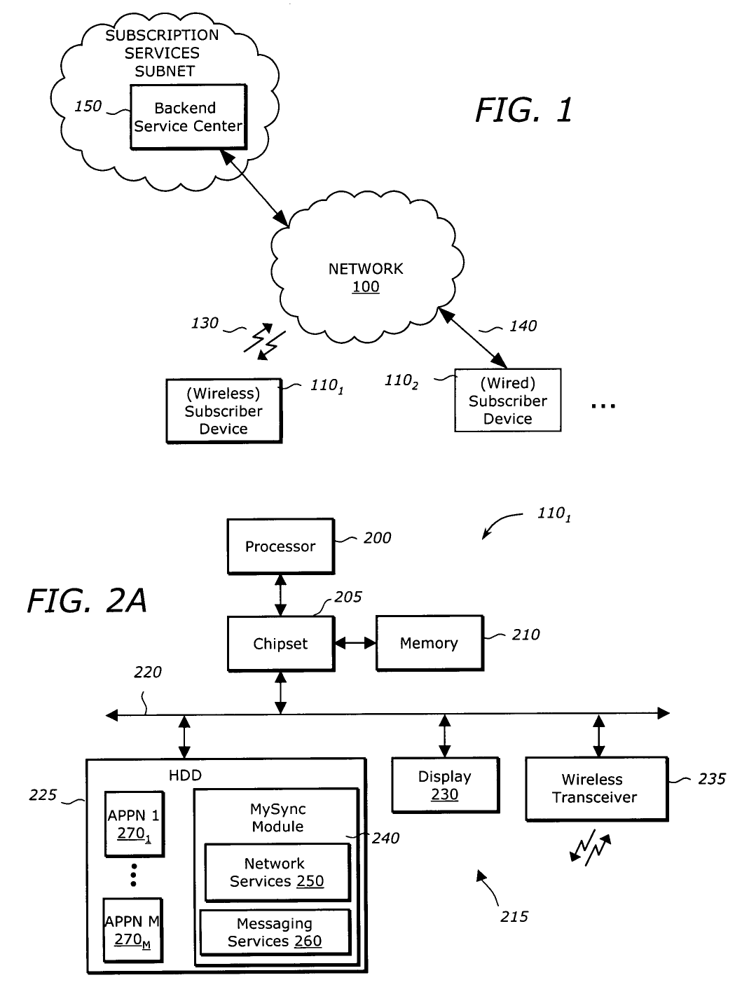

Referring to FIG. 1, an illustrative embodiment of a network implemented with a communication module described below is shown. According to one embodiment of the invention, network 100 is a public network that provides connectivity between a plurality of subscriber devices 110₁-110_{N} (N≧1) and a backend service center 150. Examples of a “public network” include a wide area network such as the Internet and/or carrier's cellular network. Of course, it is contemplated that network 100 may be a private network (e.g., local area network) or a combination of private and public networks.

As shown, for this illustrative embodiment, subscriber device 110₁ is a wireless electronic device that is capable of establishing wireless communications with network 100 through a wireless interconnect 130. These wireless communications, namely the exchange of electromagnetic waves that carry information such as radio-frequency (RF) signals or cellular signals for example, enable subscriber device 110₁ to communicate with backend service center 150 and/or another subscriber device 110₂ (e.g., desktop computer) that is coupled to network 100 over a wired interconnect 140.

As shown in FIG. 1, subscriber device 110₁ is in communication with backend service center 150, which includes a collection of one or more databases and/or network servers. After completing registration of a subscription service, such as a security service for example, backend service center 150 assists in the activation of a communication module (not shown) that monitors and controls network connectivity for subscriber device 110₁ and one or more applications (not shown) associated with the subscribed services.

This communication module is operational while subscriber device 110₁ is powered, and is prompted to establish network connectivity when subscriber device 110₁ is requested to exit from certain Advanced Configuration and Power Interface (ACPI) power-saving states (e.g., suspend “S3”, hibernate “S4”, or shutdown “S5” states). If subscriber device 110₁ is in S3, S4 or S5 states, the ACPI based timer, will bring subscriber device 110₁ to an “ON” (S0) state and perform the scheduled action. If subscriber device 110₁ is “ON” or in any of the power-saving states (S3, S4, and S5), backend service center 150 can send a message to cause the awakening of subscriber device 110₁ (if not in S0 state) and to cause subscriber device 110₁ to perform the scheduled action or retrieve information from backend service center 150.

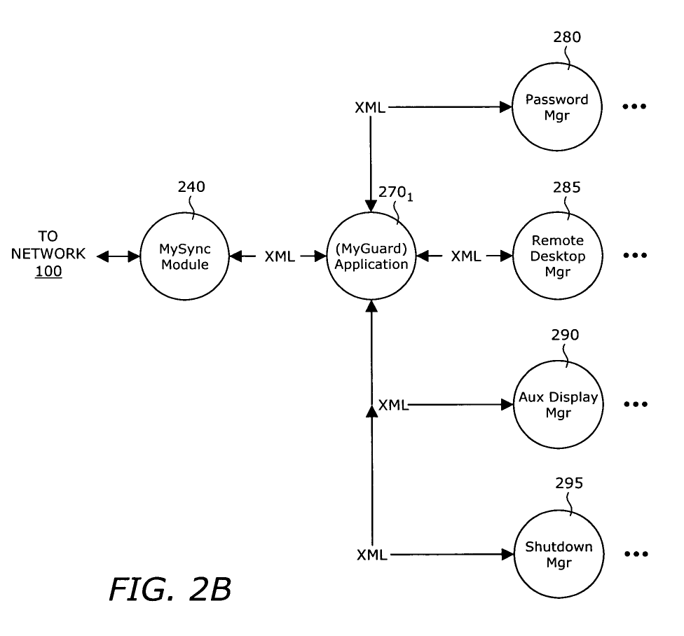

Referring now to FIG. 2A, an exemplary embodiment of the internal architecture of subscriber device 110₁ is shown. As described below, subscriber device 110₁ is implemented with a communication (MySync) module 240 that manages both network communications for one or more applications implemented within subscriber device 110₁ and the query, retrieval and processing of application-specific data.

According to one embodiment of the invention, subscriber device 110₁ comprises a processor 200 coupled to a chipset 205. Chipset 205 controls the flow of information between processor 200, a main memory 210 and a plurality of input/output (I/O) devices 215 each coupled to an internal bus 220. According to one embodiment of the invention, the plurality of I/O devices 215 include, but are not limited or restricted to a hard disk drive (HDD) 225, a display 230, and a (wireless and/or wired) transceiver 235.

As shown, according to this embodiment of the invention, hard disk drive 225 is configured to include communication module 240 (hereinafter referred to as “MySync module”), which is a series of instructions that run as a Windows® Service. Thus, MySync module 240 runs before any login sessions are active to guarantee that its services are available whenever subscriber device 110₁ is operational. Of course, it is contemplated that MySync module 240 may be configured to operate as a daemon application, namely an application operating in the background and perhaps in conjunction with the operating system (OS) of subscriber device 110₁.

According to one embodiment of the invention, MySync module 240 includes instructions, such as hard-coded instructions that are stored in persistent storage and may or may not be alterable. MySync module 240 is preloaded on hard disk drive 225, although MySync module 240 could be loaded onto hard disk drive 225 from a separate source (e.g., downloaded from backend service center 150 of FIG. 1 or uploaded from a portable storage device such as a compact disc “CD”, digital versatile disk “DVD”, flash drive, flash memory, or the like).

It is contemplated that, in lieu of and in addition to being stored within hard disk drive 225, MySync module 240 may be implemented within a different type of storage device or within transceiver 235.

Referring still to FIG. 2A, according to one embodiment of the invention, MySync module 240 provides a set of services that are used by a plurality of applications 270₁-270_{M} (where M≧1). As an illustrative example, each application 270ᵢ (where 1≦i≦M) may constitute a plug-in application that provides a particular service to the subscriber such as security, remote terminal services, syndicated content delivery, or the like.

More specifically, as shown, MySync module 240 is responsible for network services 250 such as (i) managing a polling schedule, which includes waking subscriber device 110₁ from various power-saving (S3-S5) states and (ii) establishing network (Internet) connectivity as needed. MySync module 240 is further responsible for messaging services 260 such as the query, retrieval and processing of messages. This processing includes the parsing of messages that are sent between backend service center 150 and applications 270₁-270_{M}.

Referring now to FIG. 2B, an illustrative embodiment of MySync module 240 in communication with a security-based application 270₁ is shown. According to one embodiment of the invention, MySync module 240 is software that uses an XML-based Web Services interface provided by the .NET framework. The Web Service interface deployed on a web server at the backend service center is configured, by programming or other means, to respond to polling requests (hereinafter referred to as “Web Service request messages”) and to accept status messages from MySync module 240. The status messages indicate that instructions (commands) from the web server have been completed by the targeted application (e.g., application 270₁).

In response to a local event or a remote event, MySync module 240 determines if a network connection is present. In the absence of network connectivity, MySync module 240 attempts to establish communications with the backend service center over network 100 under control by OS. If such attempts are unsuccessful or a routable network (IP) address cannot be obtained as described below, MySync module 240 controls network connectivity by attempting to establish a wireless network connection using transceiver 235 of FIG. 2A. According to one embodiment of the invention, the wireless network connection involves cellular-based communications (e.g., any packet-based digital transmission inclusive of cellular transmissions based on the Global System for Mobile Communications “GSM” standard like 3G or 4G, or cellular transmission based on Code Division Multiple Access “CDMA”).

According to one embodiment of the invention, a “local event” is an event that is prompted by components within the subscriber device. For instance, the local event may be a scheduled polling event prompted by an internal timer (e.g., RTC Wake Alarm set by programming the BIOS settings over ACPI or Serial Control Interface “SCI” interfaces). A “remote event” is an event that is prompted by a source remotely located from the subscriber device. For instance, the remote event may be signaling, such as a text message from a web server of the backend service center.

As shown, MySync module 240 is in communication with application 270₁. According to one embodiment of the invention, XML messages received by MySync module 240 may be parsed and security-based instructions may be routed to application 270₁. As further shown, application 270₁ includes a number of processes directed to security such as a password manager 280, a remote desktop manager 285, an auxiliary display manager 290, and a shutdown manager 295. Password manager 280 is responsible for setting the BIOS and HDD passwords when such action is requested. Similarly, remote desktop manager 285, auxiliary display manager 290 and shutdown manager 295 are responsible for (i) controlling remote terminal connections with another electronic device, (ii) controlling message display on an auxiliary display, and (iii) forcing shutdown of the subscriber device (or log-off of its user), respectively.

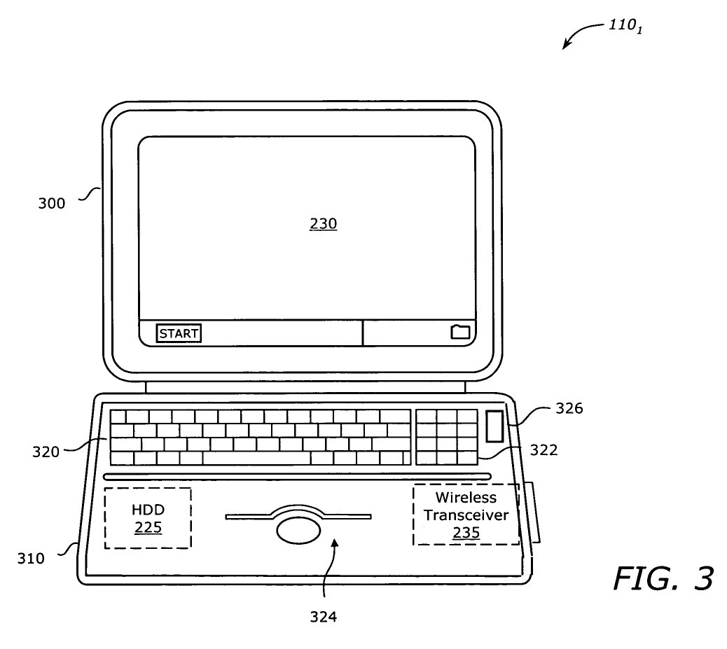

Referring now to FIG. 3, an exemplary embodiment of a block diagram of external architecture of subscriber device 110₁ of FIG. 1 is shown. Subscriber device 110₁ includes a display 300 and a main body 310. Display 300 is a casing surrounding a flat panel display 230 such as a liquid crystal display, for example.

As further shown, main body 310 operates as a housing for components 200, 205 210, 225 and 235 shown in FIG. 2A in order to protect these components from adverse environmental conditions that may damage these components. However, one or more input devices are positioned along an exterior surface of main body 310 and are accessible to the user. The input device(s) includes one or more of the following: a keyboard 320, a keypad 322, a touchpad 324, a biometric authentication device 326 or the like.

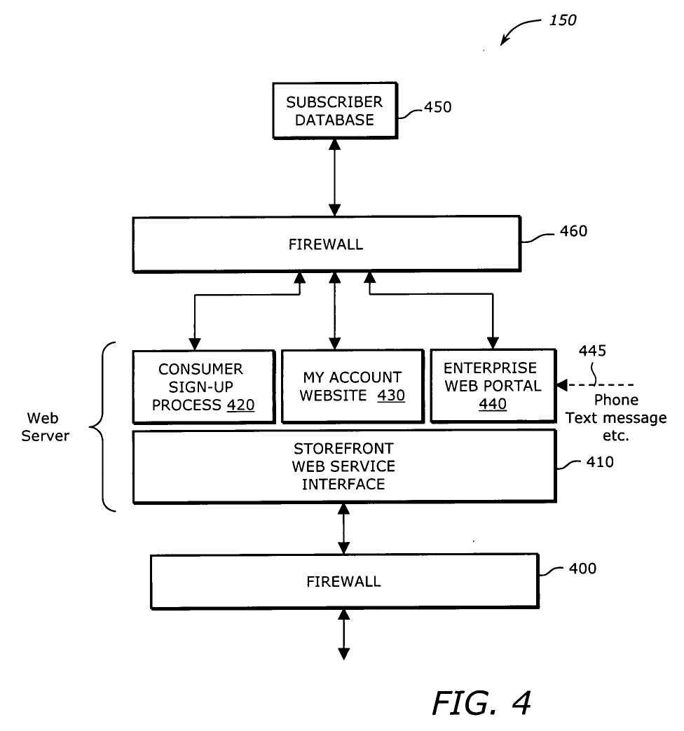

Referring now to FIG. 4, an illustrative embodiment of certain components forming one embodiment of backend service center 150 is shown. In general, backend service center 150 may be any remotely located server or device that is capable of processing information and communicating with the subscriber device. The chosen configuration of backend service center 150 is for illustrative purposes only so that an illustrative message exchange with the MySync module can be fully explained.

As shown, one embodiment of backend service center 150 is configured to allow users access a storefront web service interface 410 via a firewall 400. Firewall 400 may include certification, and thus, a secure link would be established between storefront web service interface 410 and the subscriber device. The storefront web service interface 410 provides the marketing verbiage that communicates the nature of the subscription services. Storefront web service interface 410 further includes individual or customer sign-up processes 420, “My Account” website 430 and an enterprise web portal 440.

Consumer sign-up process 420 is a process that allows consumers to create a subscription account for any available services such as device security, real-time news reporting and the like. For illustrative purposes, the device security services shall be discussed.

My Account website 430 allows each subscriber to sign in, manage his/her account and submit instructions for receipt by MySync module 240 of the subscriber device. With respect to device security, for example, My Account website 430 presents a listing of scenarios that identify the current status of each subscriber device registered by the subscriber. As described below, the listing may include a primary scenario identifying that a particular subscriber device is secure and secondary scenarios where the subscriber has lost physical control of his or her device: “Stolen,” “Lost,” or “Misplaced” (Left Behind).

In response to selection of any of these secondary scenarios, one or more messages directed to a specific application installed on the subscriber device is received by MySync module 240 of FIG. 2A, where such message(s) is (are) routed to a targeted application (e.g., application 270₁ loaded on the subscriber device). As a result, for this embodiment of the invention, the application may disable components of the subscriber device, (ii) display messages, and/or (iii) perform any other activity or series of activities designed to locate or preclude unauthorized access to stored data.

Enterprise web portal 440 provides access for enterprise administrators to add/remove subscribers and to activate or deactivate the subscriber device from its current state. Each enterprise administrator will automatically receive emails with his or her account information uniform resource locator (URL) to the enterprise web portal 440. Enterprise web portal 440 then gives these administrators full control of the subscription services for their users of course, it is contemplated that the enterprise administrator may be informed of status changes by communications 445 other than by email (e.g., phone, in-person dialogue, text message, etc.). Such communications will prompt the administrator to act accordingly.

Herein, the consumer sign-up process 420, My Account website 430 and enterprise web portal 440, are in communication with a subscriber database 450 via a firewall 460. Firewall 460 provides a secure communication path between the processes associated with storefront web service interface 410 and data stored in the subscriber database 450. The data stored within subscriber database 450 may be device-specific instructions corresponding to those actions selected for each scenario. Of course, if the instructions for each scenario are static and are not configurable by the subscriber, subscriber database 450 may store a common series of instructions for each scenario.

### II. Exemplary Architecture of the Subscription Process

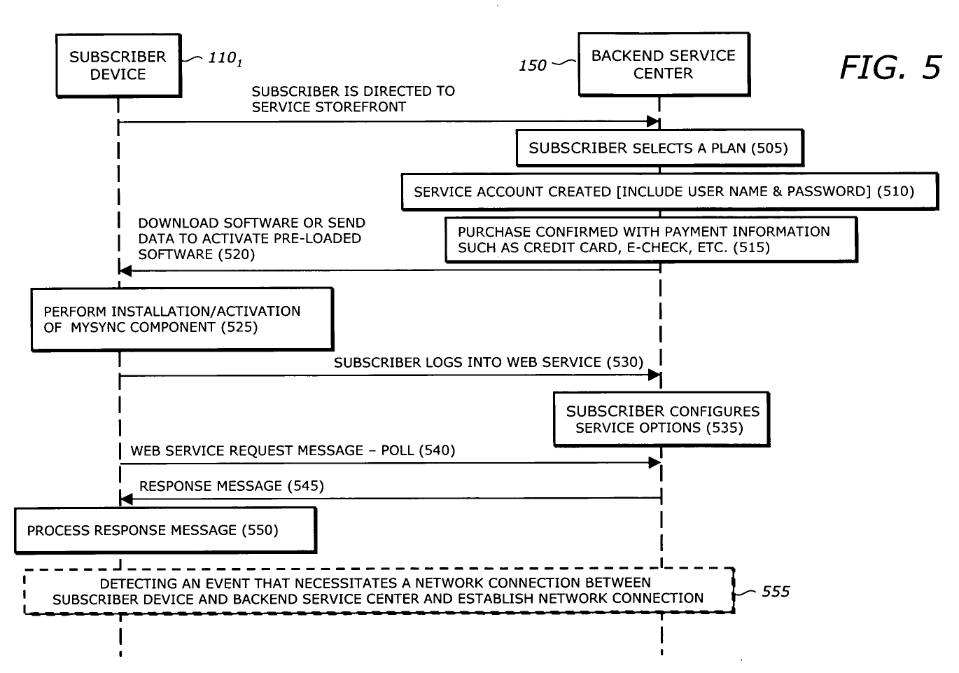

Referring now to FIG. 5, an illustrative embodiment of an exemplary embodiment of the subscription service up to detection of an event necessitating network connectivity by the subscriber device is shown. Initially, subscriber device 110₁ initiates communications to backend service center 150 as represented by operation 500. Such communications may be established by a subscriber accessing the storefront web service interface described above.

Upon establishing communications with backend service center 150, the subscriber selects a subscription plan directed to a desired service such as device security for example (operation 505). “Device security” is a service that causes the installation or activation of one or more security-based applications within subscriber device 110₁. The security-based application(s) perform activities to disable or assist in the recovery of the subscriber device. The performance of such activities may be initiated through either real-time messaging from backend service center 150 or periodic queries from the security-based applications.

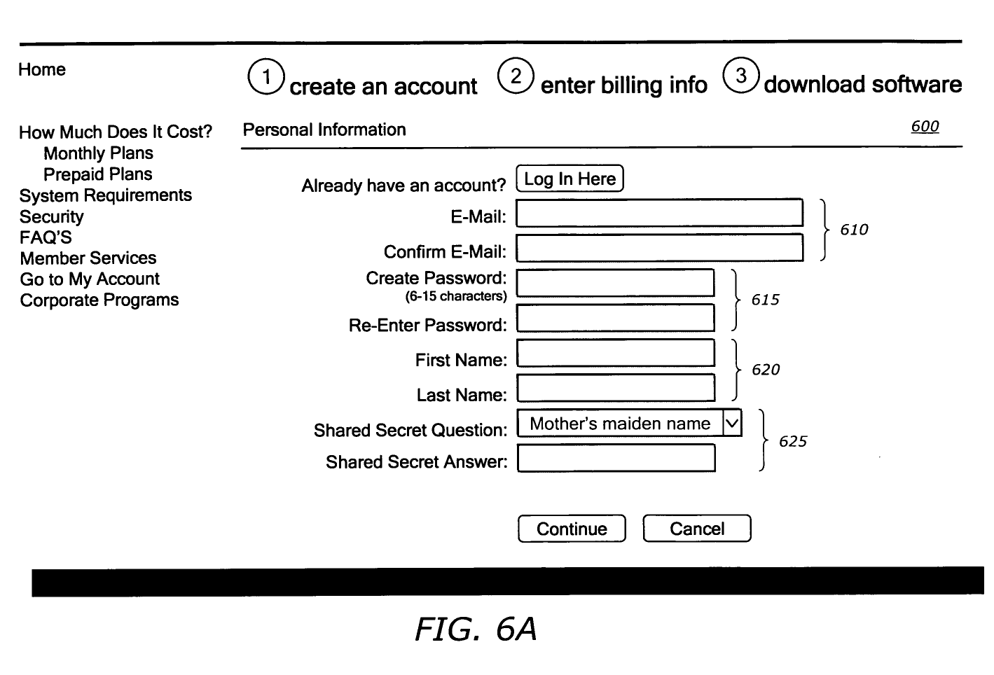

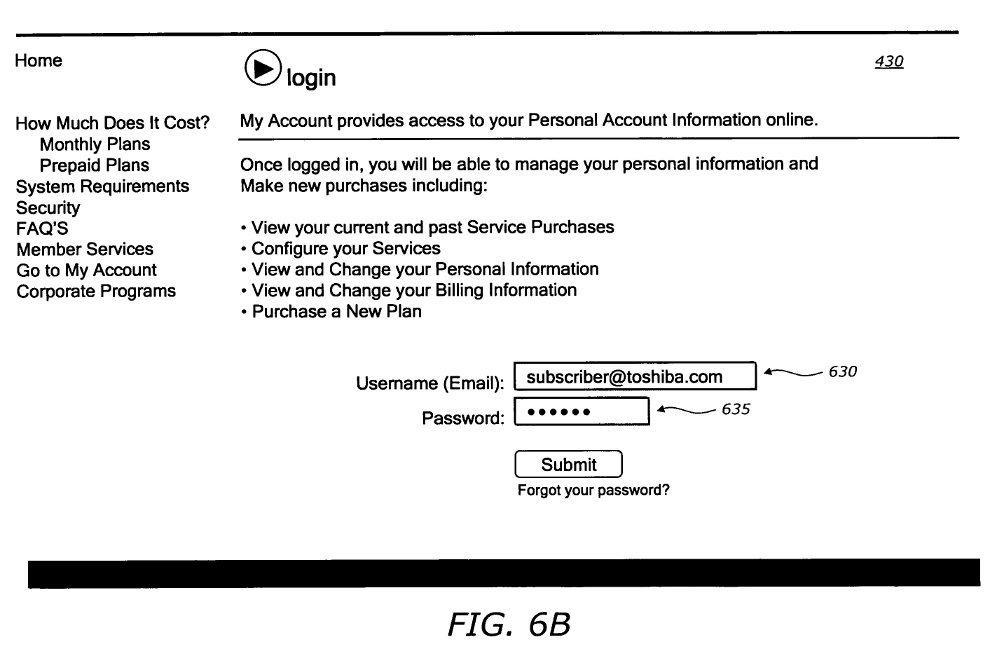

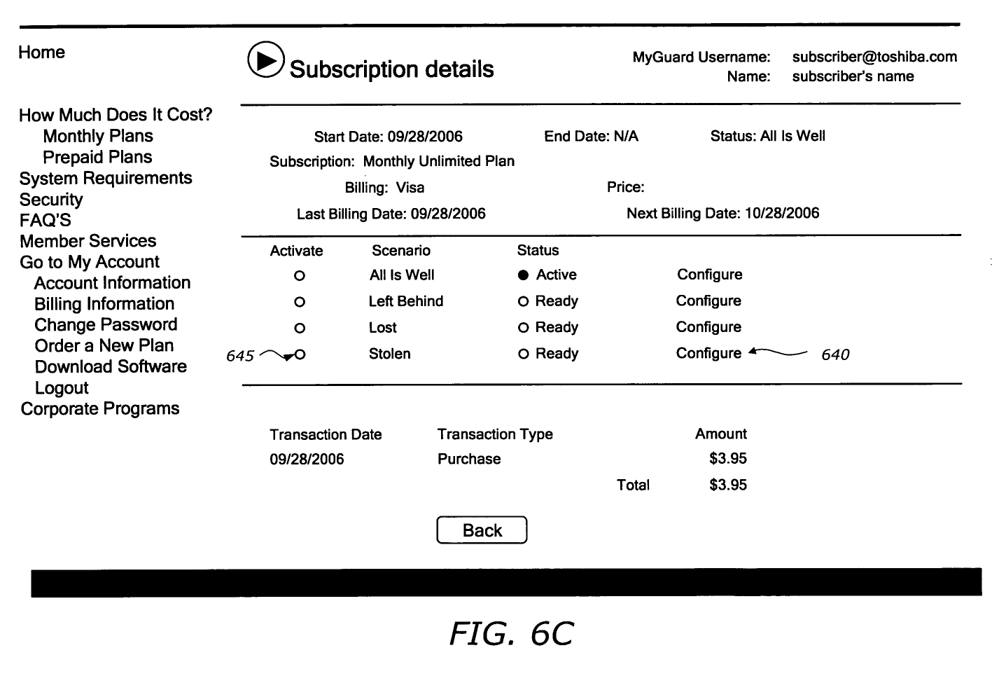

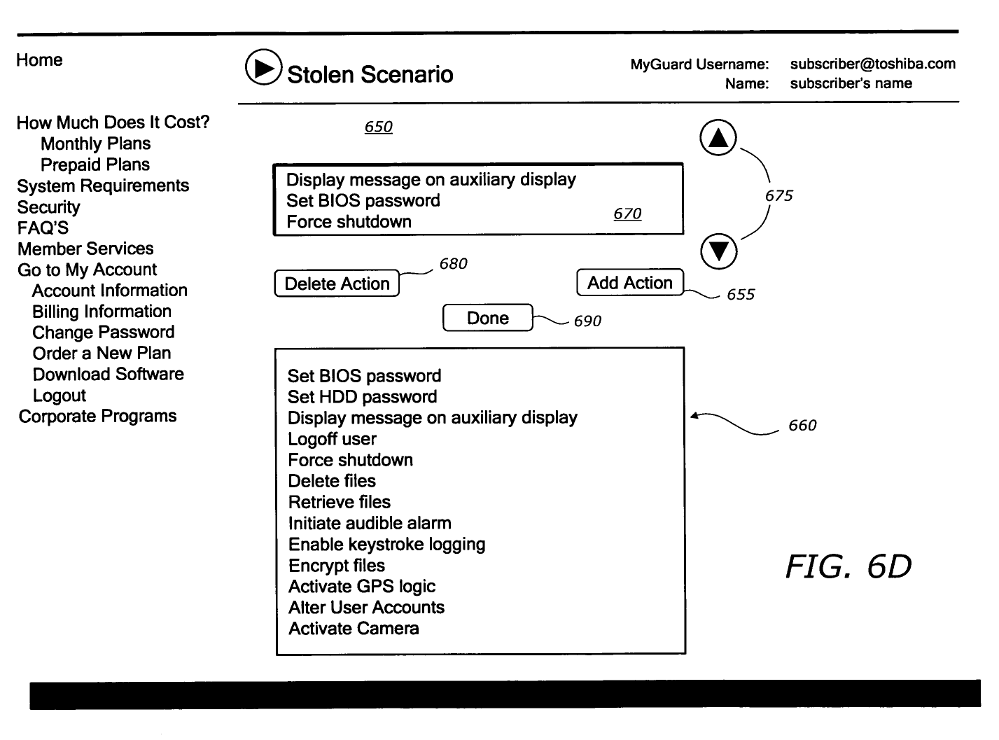

Before or after selecting the subscription plan, a service account is created in which a username and password are established for the subscriber (operation 510). As shown in FIG. 6A, according to one embodiment of the invention, the service account may be created based on information input into a subscription enrollment window 600.

For instance, as an illustrative example, the information input by the subscriber may include an electronic mail (email) address 610, a password 615 selected for accessing the service account, the first and last name of the subscriber 620, and a shared secret question and answer 625 for subscriber authentication and password resetting in the event that the subscriber forgets his or her password.

Referring back to FIG. 5, the service account is completed after confirmation that payment is received such through credit card, an electronic check (e-check) or another electronic banking mechanism (operation 515).

After the service account is established, backend service center 150 downloads software, such as a set-up program, to subscriber device 110₁ for installation of the MySync module and one or more subscriber applications (operation 520). Of course, it is contemplated that software may not be downloaded, but rather, a message may be transmitted to subscriber device 110₁ in order to activate pre-loaded applications associated with the selected services.

Thereafter, installation and activation operations are performed (operations 525). According to one embodiment of the invention, this is accomplished by subscriber device 110₁ running an activation wizard. This wizard prompts for the subscriber's current username and password, and thereafter, will securely send this information to subscriber database 450 of FIG. 4 along with optional information (e.g., ESN, phone number, computer name, model name, serial number, etc.) for identifying subscriber device 110₁ to the subscriber and backend service center 150. In response to subscriber database 450 receiving this information, a Globally Unique Identifier (GUID) will be sent to subscriber device 110₁ to be used in future communications with subscriber device 110₁ to backend service center 150. The wizard can be pre-installed on all subscriber devices to help advertise subscription services.

After installation and in order to configure the device security options, the subscriber logs into “My Account” as shown in FIG. 6B (operation 530). The subscriber login may be accomplished by providing his or her username 630, such as the subscriber's email address, and a password 635 that was selected during creation of the service account.

After logging into the storefront web service interface, the subscriber may configure options for the service account (operation 535). According to one embodiment of the invention, as shown in FIG. 6C, the configuration would involve selection of a “Configure” element 640 that corresponds to various scenarios where the subscriber requests certain actions to be performed on the subscriber device via remote signaling.

In particular, upon selecting “Configure” element 640, a “Stolen” programming page 650 is displayed as shown in FIG. 6D. Stolen programming page 650 allows one or more actions to be selected so that, upon requesting placement of the subscriber device into the “Stolen” state, backend service center 150 transmits instructions associated with the actions to subscriber device 110₁ in order to disable access to certain components, display messages, delete files or the like.

More specifically, upon selection of the “Add Action” button 655, a complete list of actions is provided in a pop-up window 660. Pop-up window 660 includes a list of all possible actions that are performed by the subscriber device when identified as being stolen by selecting an Activate button 645 corresponding to a “Stolen” scenario (see FIG. 6C). According to one embodiment, the list of actions includes some or all the following: (1) set BIOS password; (2) set HDD password; (3) display a message on a display integrated on or attached to the subscriber device; (4) log-off user; (5) force shutdown; (6) delete files; (7) retrieve files perhaps through enablement of Terminal Services; (8) initiate audible alarm; (9) enable keystroke logging; (10) encrypt files; (11) activate GPS logic; (12) alter user accounts on subscriber device 110₁; and (13) activate installed camera and control transmission of a video feed or still pictures.

Upon the subscriber selecting one or more of these actions, pop-up window 660 disappears and the selected action are now listed in an instruction window 670. Instruction window 670 identifies the actions that will be performed based on instructions that will be transmitted when the subscriber notifies backend service center 150 that the subscriber device has been stolen. These actions can be reviewed by use of scroll buttons 675 to scroll up or down.

In order to delete actions listed in instruction window 670, the action is first selected and then a “Delete Action” button 680 is selected. This will remove the selected action from instruction window 670. Upon completing the configuration, a “Done” button 690 may be selected to exit programming page 650.

Referring back to FIG. 5, subscriber device 1101 is scheduled to transmit Web Service request messages (polling requests) to backend service center 150. The exchange of some request and response messages is designed to check for updated polling information from subscription backend service center 150, even when subscriber device 110₁ is in S3-S5 states (operations 540, 545 and 550).

In response to a local event or remote event, subscriber device subscriber device 110₁ establishes a network connection to backend service center 150 (operation 555). This enables subscriber device 110₁ to receive updated polling information and/or subscription services data as described below.

### III. Exemplary Architecture of the MySync Module

A. Messaging Services

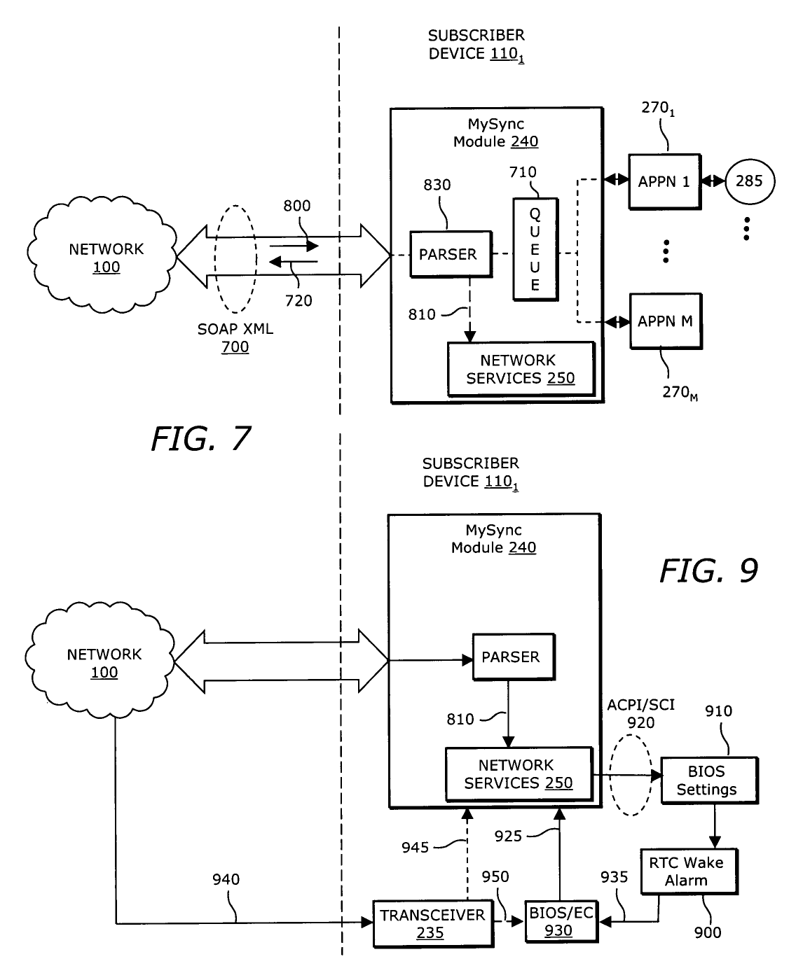

Referring now to FIG. 7, an illustrative embodiment of the block diagram describing the operations of MySync module 240 is shown. Herein, with respect to messaging services, MySync module 240 uses a Simple Object Access Protocol (SOAP) XML-based interface 700 to communicate over network 100. Interface 700 is configured to support the routing of a variety of message formats, including encapsulated XML messages, to subscriber device 110₁.

Upon receiving an encapsulated XML message 800, MySync module 240 parses XML message 800 and places this message in a message queue 710. Optionally, message 800 may be time-stamped, encoded and saved persistently. Thereafter, MySync module 240 determines which application 270₁, . . . or 270_{M} is targeted to receive information encapsulated within message 800. Of course, it is contemplated that message 800 may be directed to multiple applications and would require parsing and separate routing to multiple applications.

Upon determining the targeted application (e.g., application 270₁), MySync module 240 launches application 270₁ and then routes certain XML documents encapsulated within message 800 to application 270₁. Thereafter, application 270₁ will notify MySync module 240 when the information has been processed (e.g., any requested actions have been completed). Upon receiving such notification, MySync module 240 removes message 800 from queue 710 and forwards a status message 720 over network 100 to the Web Service so that the status can be recorded by the backend service center.

If subscriber device 110₁ is shutdown before message 800 has been processed by application 270₁, once subscriber device 110₁ is restarted, MySync module 240 will reconnect to the Web Service to determine which actions have yet to be completed, re-launch application 270, and resend the information for processing.

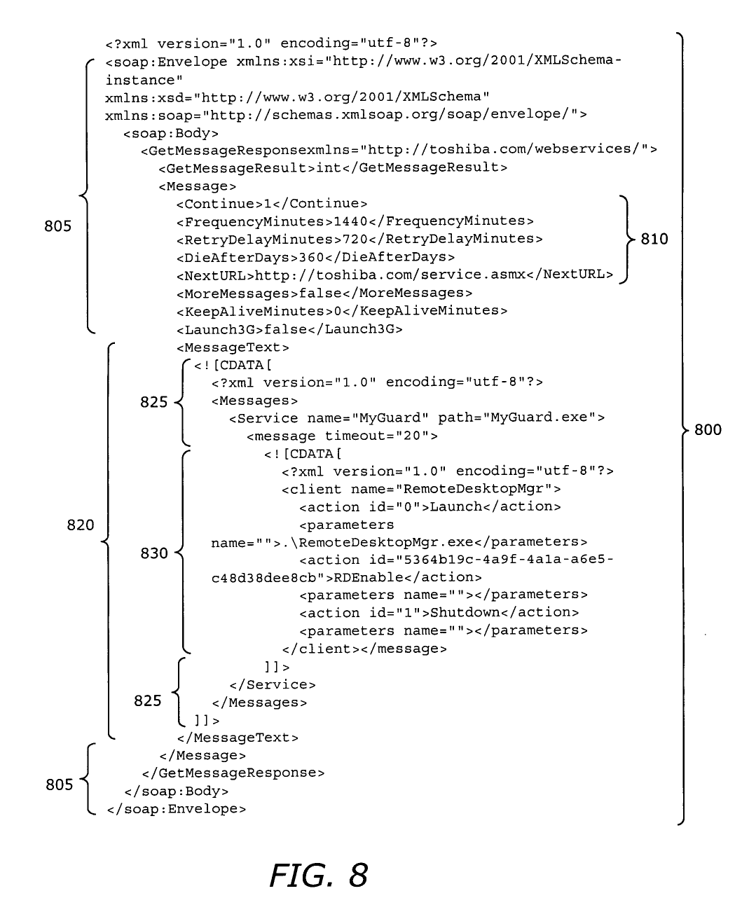

With respect to the parsing of message 800, MySync module 240 parses a portion of message 800 received over network 100, namely an encapsulated XML message, in order to recover polling parameters 810 if included. Polling parameters 810 are used by MySync module 240 to control polling operations by subscriber device 110₁. However, MySync module 240 ignores one or more inner XML documents 830 within encapsulated XML message 800. Instead, the XML document 830 is provided to one or more targeted application 270₁-270_{M}, which parse this information and perform actions based on the information. An exemplary embodiment of encapsulated XML message 800 is shown in FIG. 8.

As illustrated in FIGS. 7 and 8, an out-most XML document 805 of encapsulated XML message 800 uses the SOAP format and operates as an interface between web services and MySync module 240. Out-most XML document 805 includes polling parameters 810.

As further shown, a nested XML document 820 is encapsulated within outer-most XML document 805. Nested XML document 820 includes a plurality of inner XML documents 825 and 830 (starting with “<?xml . . . >”), each encased in CDATA tags. CDATA tags are ignored by the XML parser. If the contents of the CDATA tags were not ignored by the XML parser, it is likely that the inner-XML would cause an error in the parsing of the outer-XML, and the interface process will fail. A first inner layer of nested XML document, namely a first inner XML document 825, is parsed by MySync module 240, in order to determine how to route the next layer of the nested XML. The next layer of nested XML document, namely a second inner XML document 830, is ignored by MySync module 240 and passed onto a targeted application for subsequent parsing and performance of the requisite actions.

More specifically, as shown in FIG. 8 and in accordance with one embodiment of the invention, polling parameters 810 may include, but are not limited or restricted to the following:
string Message;
int FrequencyMinutes;
int RetryDelayMinutes;
int DieAfterDays;
string NextURL;

A first polling parameter (FrequencyMinutes) indicates to MySync module 240 how often to poll a server of the backend service center. The parameter “RetryDelayMinutes” provides MySync module 240 with information as to how much time to wait before a retry after a failed attempt to connection to the network while the parameter “DieAfterDays” identifies how long to try to attempt to establish a network connection before determining that the connection attempt has been unsucessful. The parameter “NextURL” provides MySync module 240 with an address of a server of the backend service center to use on the next polling attempt.

MySync module 240 parses first inner XML document 825 and launches one or more applications (e.g., security application 270₁) that control the individual actions to be performed. The name (MyGuard) and path (MyGuard.exe) of application 270₁ is used to locate and start security application 270₁ on subscriber device 110₁.

Lastly, second inner XML document 830 is ignored by MySync module 240. Rather, second inner XML document 830 is passed to security (MyGuard) application 270₁ after it is launched. Second inner XML document 830 is parsed by security application 270₁ and routes to a process (remote desktop manager 285) that will perform the action(s) listed (Shutdown). It is the CDATA XML type that is used to encapsulate the nested XML interface layers.

In summary, MySync module 240 parses the encapsulated XML message received over network 100. The parsed values contain parameters used to control the polling events and may contain one or more commands to be passed on to various components. The command specifies the component to activate (e.g., application to launch) as well as at least one XML-based instruction to be passed to the component. The XML-based instruction is encoded so that it is not parsed by MySync module 240. Therefore, the details of the instruction do not need to be understood by MySync module 240. Instead, the instruction is interpreted by the application targeted to receive the instruction. This allows MySync module 240 to remain unchanged as additional components, having disparate and arbitrarily complex interfaces, are installed.

B. Network Services

Referring now to FIG. 9, an exemplary embodiment illustrating the control of network communications by MySync module 240 is shown. MySync module 240 supports network connectivity that is initiated by subscriber device 110₁ (e.g., polling events, messages from applications, etc.) and network connectivity based on signaling received from a remote source.

With respect to polling operations, MySync module 240 manages the polling interval and scheduling by setting RTC Wake Alarm 900 via BIOS setting 910 (over ACPI or SCI interface 920) to commence wake-up of subscriber device from S3, S4 or S5 states. According to one embodiment, this may be accomplished by signaling 925 from a component 930 (e.g., BIOS or embedded controller “EC”) in response to an RTC Wake event 935. The polling interval and scheduling may be modified by the subscriber or by the Web Service through transmission of modified polling parameters 810 as described above.

When it is time to poll or perform a particular task requiring network connectivity, MySync module 240 determines whether network connectivity is present. If not, MySync module 240 will automatically attempt to establish network connectivity. For instance, MySync module 240 may attempt to establish a network connection over a wired interconnect if subscriber device 110₁ features a wired transceiver. If such attempts are unsuccessful, however, MySync module 240 automatically establishes a wireless (e.g., 3G or 4G) network connection using the wireless transceiver (e.g., activating a 3G or 4G-cellular transceiver implemented within subscriber device 110₁). In one embodiment of the invention, MySync module 240 will iterate over a number of potential network connectivity options in its attempt to establish network connectivity. Potential network connectivity options may include Ethernet, phone line modems, WiFi, Bluetooth®, 3G, 4G, or any other means that allows MySync module 240 to establish connectivity with network 100.

Besides for polling and scheduling purposes, MySync module 240 is adapted to establish network connectivity based on signaling 940 from a remote source over a wired medium (e.g., “Wake On LAN” signaling, phone call over landline, etc.) or signaling 940 over a wireless medium (e.g., radio frequency signal, cellular signal, wireless text message, etc.). MySync module 240 is operational while subscriber device 110₁ is in S0 state, and therefore, is notified to established network connectivity by transceiver 235 via signaling 945. However, when subscriber device 110₁ is in a power-saving state (S3-S5), MySync module 240 is inoperable and is activated by component 930 after its receipt of a Wake command 950 from transceiver 235. This requires transceiver 235 to be powered during all power-saving states.

Thereafter, MySync module 240 will establish network connectivity with the backend service center. This will enable subscriber device 110₁ to receive instructions that perform certain actions such as one or more of the security-based action illustrated in FIG. 6D.

It is contemplated that user intervention may be required during the boot process in response to a wake event (e.g., BIOS password is set and the device is going from S5 to S0). This may be addressed by having a trusted relationship between the BIOS and the component requesting the wake, such as a transceiver 235 or the RTC Wake Alarm 900 for example, allowing the BIOS to bypass user intervention. This trusted relationship may be further secured by having a component in S0 (e.g., a Windows® service or daemon process) that queries the BIOS as to what user intervention was bypassed and then takes responsibility for requesting the user intervention that was bypassed by the BIOS.

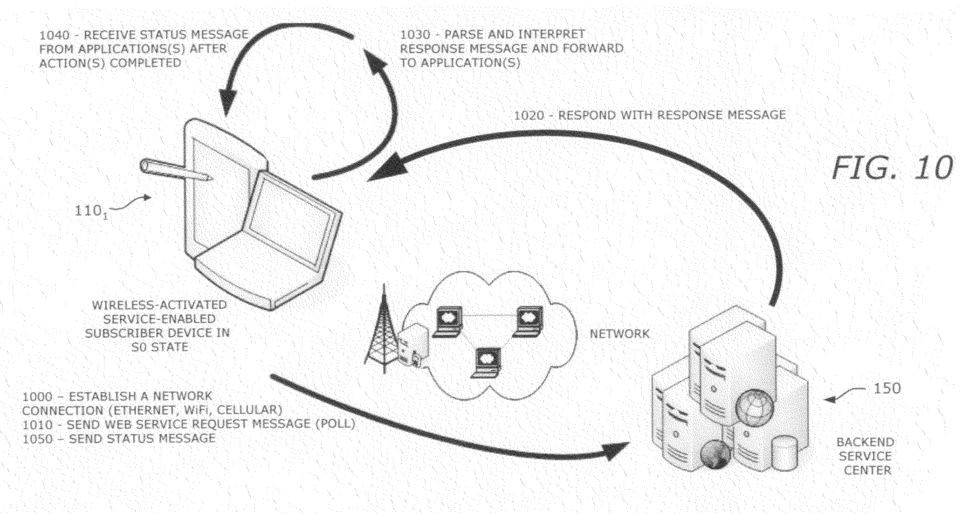

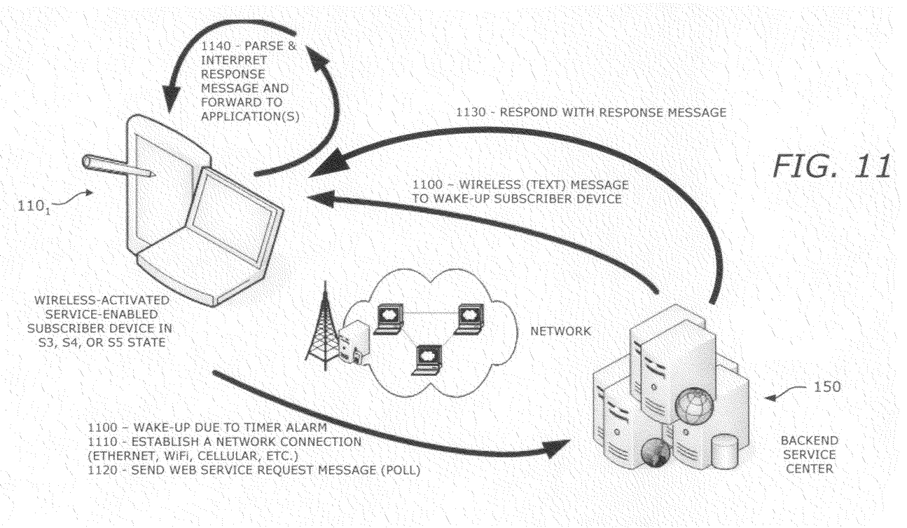

Referring now to FIG. 10, an illustrative embodiment of the operations of subscriber device 110₁ and backend service center 150 is shown. Subscriber device 110₁ is in an operational (S0) state and detects a local event. In other words, the MySync module detects a polling event, and in response, establishes network connectivity and sends a Web Service request message to backend service center 150 (operations 1000 and 1010).

Upon receiving the Web Service request message and confirming an active subscription, backend service center 150 provides a Response message to subscriber device 110₁ (operation 1020). The Response message may include subscription services data, polling parameters or the like. If the Response message is an encapsulated XML message as described above, the MySync module within subscriber device 110₁ parses and interprets the Response message, and if necessary, forwards instructions corresponding to an action to be performed by a targeted application (operation 1030). In addition, the MySync module receives a Status message once the requested action has been completed (operation 1040). The Status message is forwarded to backend service center 150 for recordation purposes (operation 1050).

Referring to FIG. 11, another illustrative embodiment of the operations of subscriber device 110₁ and backend service center 150 is shown. Subscriber device 110₁ is in a power-saving state (S3, S4 or S5 state) and is awakened by a polling event timer or a wireless (text) message from backend service center 150 (operation 1100). In other words, the MySync module detects an event (local or remote), and in response, establishes network connectivity and sends a Web Service request message to backend service center 150 (operations 1110 and 1120).

Upon receiving the Web Service request message, backend service center 150 provides a Response message to subscriber device 110₁ (operation 1130). Similar to FIG. 10, the Response message may include subscription services data, polling parameter, etc. If the Response message is an encapsulated XML message as described above, the MySync module within subscriber device 110₁ parses and interprets the Response message, and if necessary, forwards instructions corresponding to an action to be performed by a targeted application (operation 1140).

Although not shown, as an optional feature, subscriber device 110₁ may receive a Status message from the targeted application if the requested action has been completed. The Status message could be forwarded to backend service center 150 for recordation purposes as described above.

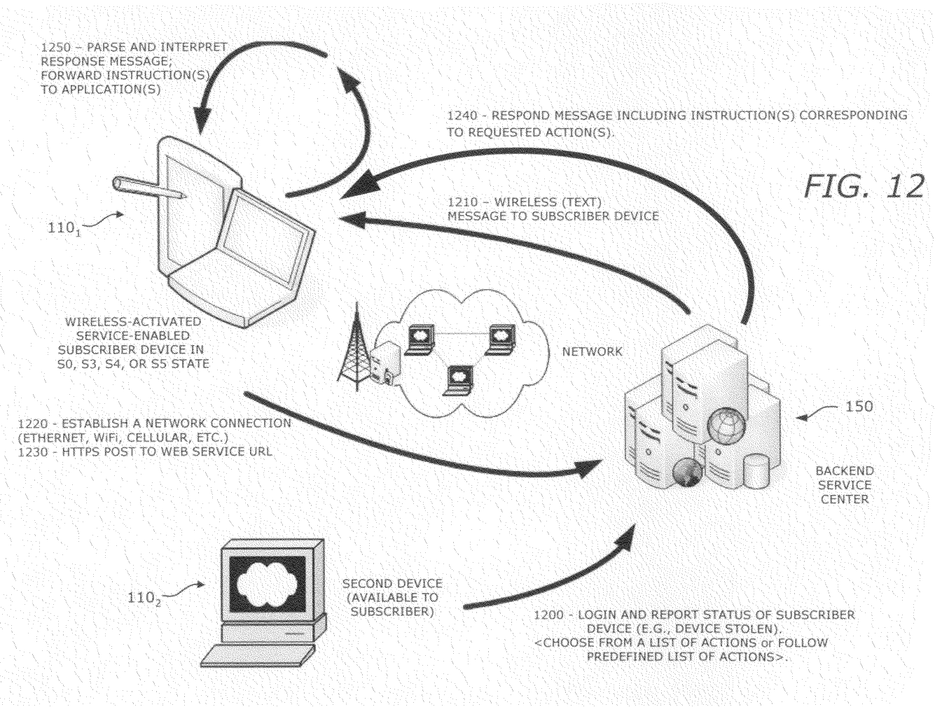

Referring to FIG. 12, an illustrative embodiment of subscription services provided by backend service center 150 to subscriber device 110₁ is shown. Subscriber device 110₁ is either in a fully operational state (S0) or in a power-saving state (S3-S5 state), and the subscriber has discovered that the device has been stolen.

As shown, the subscriber establishes a network connection to backend service center 150 using another subscriber device 110₂ and, since subscriber device 110₁ has been stolen, the subscriber sets the status of subscriber device 110₁ to “Stolen” (operation 1200). In response to this status setting operation, backend service center 150 transmits a wireless message to subscriber device 110₁ in the event that subscriber device 110₁ is in a power-saving (S3-S5) state (operation 1210). As an optional feature, although not shown, a message with instructions corresponding to the actions requested by the subscriber when subscriber device 110₁ is stolen may be sent concurrently in case subscriber device 110₁ is operational (S0 state).

Upon the MySync module of subscriber device 110₁ detecting the wireless message, it establishes network connectivity and connects to backend service center 150 (operations 1220 and 1230). Thereafter, backend service center 150 transmits a message including instructions corresponding to the list of requested actions predefined by the subscriber or a newly generated list of actions to be performed in the event that subscriber device 110₁ is stolen (operation 1240).

The MySync module of subscriber device 110₁ parses the message, routes the instructions to one or more subscriber applications and launches these applications to perform the requisite actions such as those illustrated in FIG. 6D (operation 1250). As a result, subscriber device 110₁ may be controlled regardless whether in an operational (S0) state or in any power-saving (S3-S5) state.

Although not shown, as an optional feature, subscriber device 110₁ may receive a Status message from the subscriber application(s) once the action(s) have been completed. The Status message could be forwarded to backend service center 150 for recordation purposes as described above.

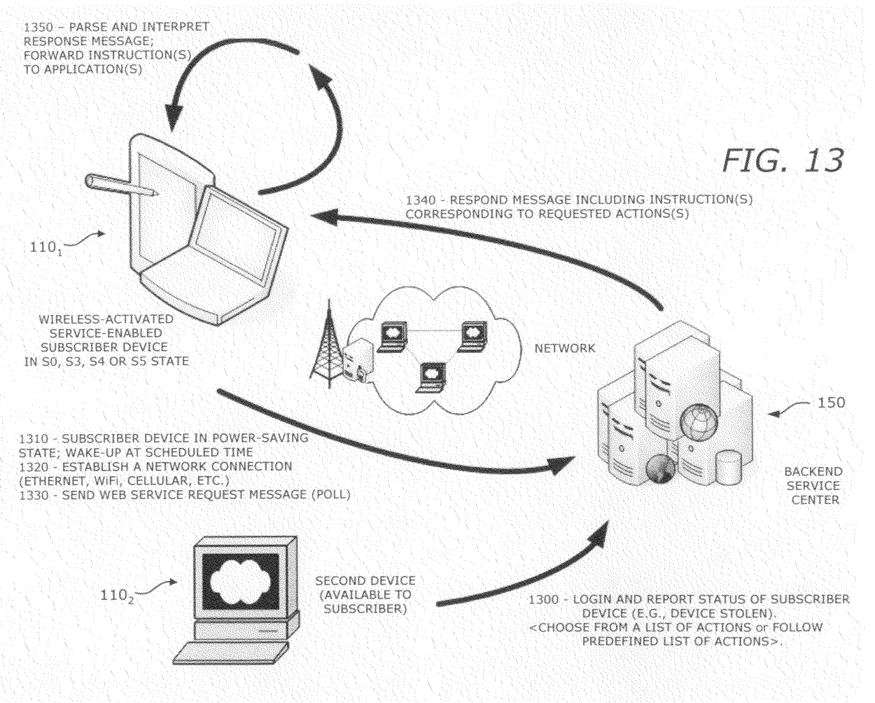

Referring to now FIG. 13, another illustrative embodiment of subscription services provided by backend service center 150 to subscriber device 110₁ is shown. Herein, subscriber device 110₁ is either in a power-saving state (S3-S5 state) or in the operational state (S0) and it is desired to perform security operations upon the subscriber discovering that the device has been stolen.

As shown, the subscriber establishes a network connection to backend service center 150 using another subscriber device 110₂ and, since subscriber device 110₁ has been stolen, the subscriber sets the status of subscriber device 110₁to “Stolen” (operation 1300). In response to this status setting operation, backend service center 150 has no wireless text messaging capability or fails to successfully transmit a Wireless message to subscriber device 110₁. Instead, during a polling event, subscriber device 110₁ awakes from a power-saving (S3-S5) state, establishes network connectivity and sends a Web Service request message to backend service center 150 (operations 1310, 1320 and 1330). In response, backend service center 150 transmits a message including instructions corresponding to the list of requested actions predefined by the subscriber or a newly generated list of actions to be performed on subscriber device 110₁ in the event that subscriber device 110₁ is stolen (operations 1340).

The MySync module of subscriber device 110₁ parses the message, launches one or more applications and routes the instructions to these applications to perform the requested actions (operation 1350). As a result, subscriber device 110₁ is controlled by a remote source even when existing in any power-saving (S3-S5) state.

Again, although not shown, as an optional feature, subscriber device 110₁ may receive a Status message from the subscriber application(s) once the action(s) have been completed. The Status message could be forwarded to backend service center 150 for recordation purposes as described above.

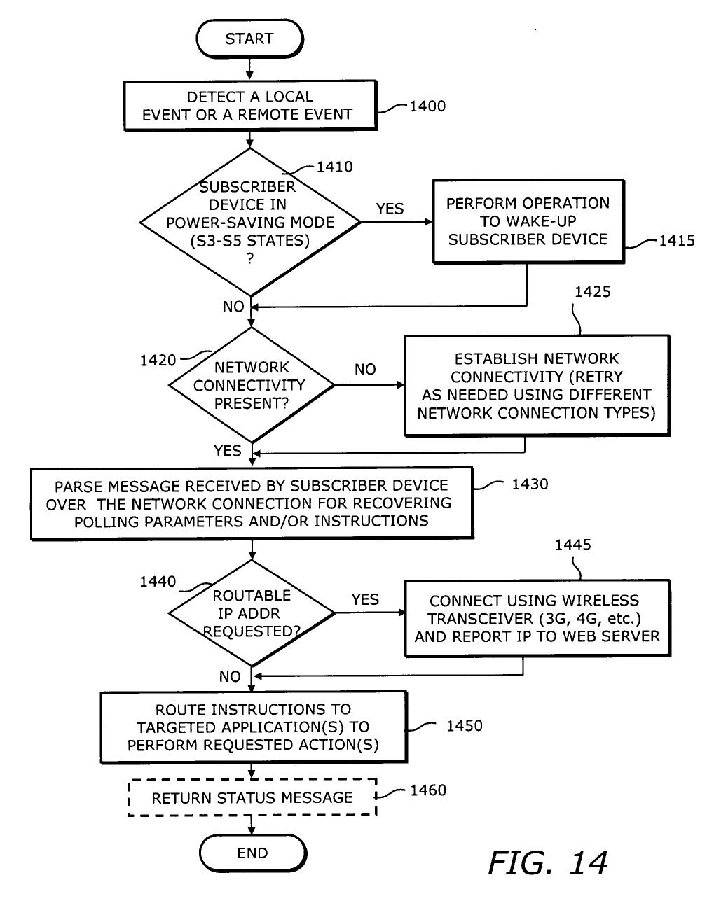

Referring to now FIG. 14, an illustrative embodiment of operations performed by subscriber device 110₁ is shown. In response to a local or remote event, detected by either the MySync module or a powered-on transceiver, a determination is made whether the subscriber device is in a power-saving (S3-S5) state (blocks 1410 and 1420). If so, a wake-up operation is performed to temporarily place the subscriber device into an operational (S0) state (block 1415). As a result, the MySync module is active.

Thereafter, the MySync module determines whether the subscriber device has network connectivity, and if not, establishes network connectivity through a wired or wireless interconnect (blocks 1420 and 1425).

Once network connectivity is established, the MySync module retrieves a message from the backend service center and parses the message to recover polling parameters, instructions for various services or subscription data (block 1430). Where the instructions are directed to the fact that the existing network connection does not provide a server (of the backend service center) a routable IP address to the subscriber device, the server provides instructions to the MySync module to re-establish network connectivity (block 1440). This may involve establishing a connection using the wireless transceiver and report the new IP address to the server (block 1445).

The new IP address is then reported to the backend service center, which again evaluates the supplied IP address to determine if it is routable. This routable IP address evaluation can be done using a variety of techniques. For instance, the IP address may be determined to be “routable” by comparing the reported IP address to the source IP address of the data packet. As another example, the routable IP address evaluation can also be performed by comparing the reported IP address to a known list of private IP addresses, such as 192.168.0.0/16, 10.0.0.0/8, etc.

Upon completion of any actions requested, a status message may be returned to the MySync module and forward to the backend service center for recordation that the action was completed (block 1460).

In the foregoing description, the invention is described with reference to specific exemplary embodiments thereof. It will, however, be evident that various modifications and changes may be made thereto without departing from the broader spirit and scope of the present invention. Therefore, the specification and drawings are accordingly to be regarded in an illustrative rather than in a restrictive sense.

What is claimed is:

1. A communication module stored with machine-readable medium implemented within an electronic device and executed by a processor of the electronic device to detect signaling identifying a wake-up event and to automatically establish connectivity to a network in response to detecting the signaling.

2. The communication module of claim 1 wherein the wake-up event is signaling initiated from an RTC Wake Alarm.

3. The communication module of claim 1 wherein the wake-up event is signaling initiated from a wireless message received by a transceiver implemented within the electronic device and powered even though the electronic device is in a power-saving state.

4. The communication module of claim 3 wherein the power saving state is a Shutdown (S5) state.

5. The communication module of claim 3 wherein the power saving state is a Hibernate (S4) state.

6. The communication module of claim 1 wherein the wake-up event is signaling initiated from a message over a wired medium that is received by a transceiver implemented within the electronic device and powered even though the electronic device is in a Shutdown (S5) state.

7. The communication module of claim 1 establishing network connectivity by providing a routable IP address.

8. The communication module of claim 1 further configured to process a message from a remote source in communication with the electronic device over the network and to set a Basic Input Output System (BIOS) password for the electronic device in response to receiving the message.

9. The communication module of claim 1 further configured to process a message from a remote source in communication with the electronic device over the network and to set a hard disk drive (HDD) password for the electronic device in response to receiving the message.

10. The communication module of claim 1 further configured to receive a message from a remote source in communication with the electronic device over the network and to conduct a forced shutdown in response to receiving the message.

11. The communication module of claim 1 further configured to receive a message from a remote source in communication with the electronic device over the network and to retrieve files from the electronic device for transmission to the remote source in response to receiving the message.

12. The communication module of claim 1 further configured to receive a message from a remote source in communication with the electronic device over the network and to activate global position satellite logic in response to receiving the message.

13. The communication module of claim 1 further configured to parse the message, being an encapsulated messages where encapsulation being used as an extensible interface between the communication module and a plurality of applications.

14. The communication module of claim 13 wherein the encapsulated message is a plurality of nested Extensible Markup Language (XML) documents.

15. The communication module of claim 14 wherein the first nested XML document is parsed to a first application while a second nested XML document is parsed to a second application.

16. A method for protecting an electronic device, comprising:
detect signaling identifying a wake-up event while the electronic device is in a power-saving state, the wake-up event being either initiated by a wireless message received from a remote source or initiated by a Real-Time Clock (RTC) Wake Alarm; and
automatically establishing network connectivity in response to detecting the signaling.

17. The method of claim 16 wherein the power saving state is a Shutdown (S5) state.

18. The method of claim 16 wherein the power saving state is a Hibernate (S4) state.

19. An electronic device, comprising:
a bus;
a processor coupled to the bus;
a display coupled to the bus;
a transceiver coupled to the bus; and
a storage device coupled to the bus, the storage device including a remote communication module that, when executed by the processor, enables the electronic device while in a power-saving state to (i) detect signaling identifying a wake-up event initiated by an incoming wireless message or initiated by a Real-Time Clock (RTC) Wake Alarm and (ii) automatically establish network connectivity in response to detecting the signaling.

20. The electronic device of claim 19 wherein the power saving state is a Shutdown (S5) state.
